(19) United States
(12) Patent Application Publication
(10) Pub. No.: US 2008/0017024 A1
(43) Pub. Date: Jan. 24, 2008

(54) PISTON FOR INTERNAL COMBUSTION ENGINE

(76) Inventors: Jan A. Ruble, Statham, GA (US); James L. Campbell, Lawrenceville, GA (US); Navid Yavari, Alpharetta, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(21) Appl. No.: 11/458,146

(22) Filed: Jul. 18, 2006

(51) Int. Cl. F16J 1/00

(52) U.S. Cl. 92/172

(57) ABSTRACT

A piston assembly includes a cross-head piston and a cylindrical cross pin. The cross-head piston includes a piston head having a cylindrical wall, a lateral surface and an opposite inward surface. Two spaced-apart connection ears, each having a proximal end and an opposite distal end, extend outwardly from the inward surface. Each proximal end is affixed to the inward surface and each distal end defines a pin bore passing therethrough. A piston well is defined by the inward surface and the connection ears. The cylindrical cross pin is disposed coaxially with a central axis so as to be engaged with both pin bores. The cross pin defines a central cross pin oil passage passing transversely to the central axis. The cross pin is placed in relation to the piston head so that the second end of the cross pin oil passage is directed to the piston well.

### BACKGROUND OF THE INVENTION

1. Field of the Invention

The present invention relates to internal combustion engines and, more specifically, to a cross-head piston for use in an internal combustion engine.

2. Description of the Prior Art

Internal combustion engines, such as diesel and gasoline engines, are heat engines in which the burning of a fuel occurs in a confined space to create gases of high temperature and pressure. The gasses are permitted to expand in the engine to do work. Typically, an internal combustion engine includes a cylinder into which fits a piston. The fuel is burned in the space between the cylinder and the piston, driving the piston outwardly when the burning gasses expand. The piston is usually coupled to a connecting rod, which transfers the reciprocating lateral motion of the piston to a crank shaft. The crankshaft translates the lateral motion to rotary motion, which is ultimately applied to perform useful work.

A typical piston includes a piston head having a diameter corresponding to the diameter of the cylinder into which the piston fits. Two spaced apart connecting ears extend from the piston head and connect the piston head to the connecting rod. Each connecting ear includes a pin bore into which fits a pin to which the connecting rod is coupled.

One type of existing piston is a cross-head piston, in which the connecting rod is bolted to the pin (also referred to as a “cross pin”). The connecting rod includes an elongated oil passage and the cross pin defines a passage therethrough that is in alignment with the oil passage of the connecting rod. In this way, oil passes through the elongated oil passage into an area around the piston, thereby providing lubrication and cooling. Existing cross-head pistons also include oil return holes in the pin bearing area for allowing oil to flow out of the piston head. Such oil return holes can become plugged due to accumulation of ash and varnish as a result of high piston temperatures. Plugged return holes reduce cooling of the piston and can shorten the lifespan of the piston.

Most existing cross-head pistons are cast from steel and are machined to form surfaces in moving contact with other parts (e.g., the cylinder). The pin bore of a typical cross-head piston includes a replaceable bushing that must be held in place with a sleeve locking device (such as a detente in alignment with a corresponding hole). The bushings wear out frequently and are costly to replace. Also, cast steel pistons are relatively weak and subject to fatigue.

Another type of piston is a forged steel piston, in which both the connecting rod and the connecting ears are rotatably coupled to the pin. Usually, an additional sleeve prevents the pin from moving laterally and damaging the cylinder. A forged steel piston usually includes a well formed between the piston head and the connecting ears in which oil flows freely. Forged steel has the advantage over cast steel of being less susceptible to fatigue.

Large commercial vehicles often employ diesel engines that are used for many years. The pistons in such engines are replaced at regular service intervals. Because existing cross-head pistons employ connecting rods that are required to be bolted to the corresponding cross-pins, forged steel pistons cannot be used as replacement parts in engines employing cross-head pistons without also replacing the connecting rods. Purchasing new connecting rods to replace serviceable connecting rods is costly and wasteful. Also, failure analysis of diesel engines indicates that the ring groves in a forged steel piston tend to wear out before the bushing surfaces in contact with the cross-pin.

Therefore, there is a need for a cross-head piston that provides the advantages and strength of forged piston.

There is also a need from a cross-head piston that does not require a bushing.

### SUMMARY OF THE INVENTION

The disadvantages of the prior art are overcome by the present invention which, in one aspect, is a piston assembly that includes a cross-head piston and a cylindrical cross pin. The cross-head piston includes a piston head having a cylindrical wall, a lateral surface and an opposite inward surface. Two spaced-apart connection ears, each having a proximal end and an opposite distal end, extend outwardly from the inward surface. Each proximal end is affixed to the inward surface and each distal end defines a pin bore passing therethrough. A piston well is defined by the inward surface and the connection ears. The cylindrical cross pin is disposed coaxially with a central axis so as to be engaged with both pin bores. The cross pin defines a central cross pin oil passage, having a first end and an opposite second end, passing transversely to the central axis. The cross pin is placed in relation to the piston head so that the second end of the cross pin oil passage is directed to the piston well.

In another aspect, the invention is a piston assembly that includes a cross-head piston made of forged steel, a cylindrical cross pin and an elongated connecting rod. The cross-head piston includes: a piston head having a cylindrical wall, a lateral surface and an opposite inward surface; two spaced-apart connection ears each having a proximal end and an opposite distal end, each proximal end affixed to the inward surface and each connection ear extending outwardly from the inward surface, each distal end defining a pin bore passing therethrough; and a piston well defined by the inward surface and the connection ears. The cylindrical cross pin is disposed coaxially with a central axis so as to be engaged with both pin bores and in direct contact with both mounting ears without any intervening bushing. The cross pin defines a central cross pin oil passage, having a first end and an opposite second end, passing transversely to the central axis. The cross pin is placed in relation to the piston head so that the second end of the cross pin oil passage is directed to the piston well. The elongated connecting rod includes a seat end and an opposite crank end that defines an elongated rod oil passage. The elongated rod oil passage has a first end and an opposite second end opening to the seat end. The seat end of the connecting rod is bolted to the cross pin so that the second end of the rod oil passage is in alignment with the first end of the cross pin oil passage.

In yet another aspect, the invention is a method of making a cross head piston that is connectable to a connecting rod with a cross pin defining an oil passage transversely therethrough. A piston blank is forged from steel so as to include: a piston head having a inward surface; two spaced-apart connection ears each having a proximal end and an opposite distal end, each proximal end affixed to the inward surface and each connection ear extending outwardly from the inward surface; and a piston well defined by the inward surface and the connection ears. The piston blank is machined so that the piston head includes a cylindrical wall and a lateral surface disposed oppositely from the inward surface. A pin bore is drilled through each connection ear so that the pin bore has a diameter corresponding to a diameter of the cross pin so that the cross pin fits into the pin bore without room for a bushing to be placed therein.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a perspective view of one representative embodiment of a piston assembly.

FIG. 2 is a cross-sectional view of the piston assembly shown in FIG. 1, taken along line 2-2′.

FIG. 3 is a cross-sectional view of the piston assembly shown in FIG. 1, taken along line 3-3′.

FIG. 4 is a detailed cross-sectional view from FIG. 2 showing a piston head.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

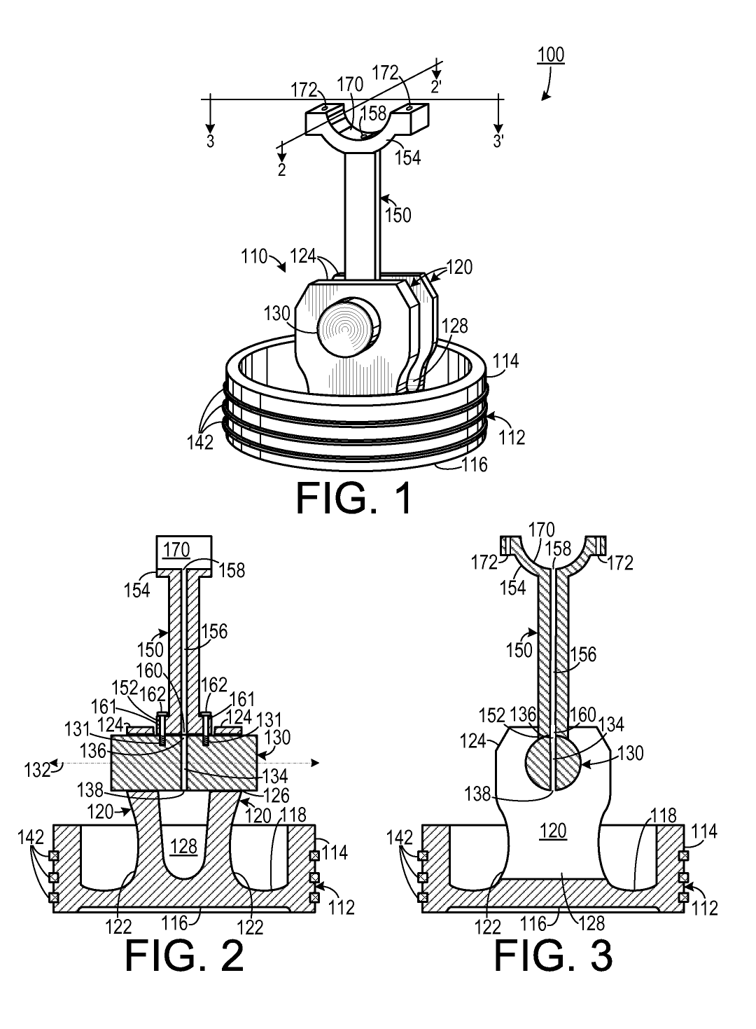

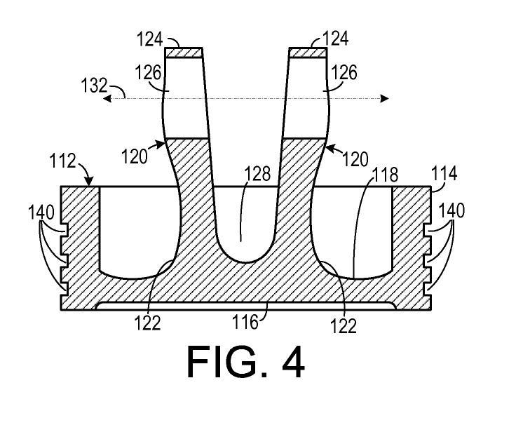

As shown in FIGS. 1-4, one embodiment of the invention is a piston assembly 100, which includes a cross-head piston 110 that is made of forged steel. The cross-head piston 110 includes a piston head 112 that has a cylindrical wall 114, a lateral surface 116 and an opposite inward surface 118. Two spaced-apart connection ears 120 each have a proximal end 122 and an opposite distal end 124. Each proximal end 122 is affixed to the inward surface 118 so that each connection ear 120 extends outwardly from the inward surface 118. Each connection ear 120 defines a pin bore 126 passing through the connection ear 120 adjacent to the distal end 124. A piston well 128 is defined by the inward surface 118 and the connection ears 120. The cylindrical wall 114 defines at least one circumferential ring groove 140 into each of which is placed a piston ring 142.

A cylindrical cross pin 130 is disposed coaxially with a central axis 132 so that it is engaged with both pin bores 126 and is in direct contact with both mounting ears 120 without any intervening bushing. The cross pin 130 defines a central cross pin oil passage 134. The central cross pin oil passage 134 has a first end 136 and an opposite second end 138. The central cross pin oil passage 134 passes transversely to the central axis 132. The cross pin 130 is placed in relation to the piston head 112 so that the second end 138 of the oil passage 134 is directed to the piston well 128.

An elongated connecting rod 150 includes a seat end 152 and an opposite crank end 154 with a crank bearing portion 170 affixed thereto. The crank bearing portion 170 defines two spaced-apart holes 172 used to bolt a second crank bearing portion (not shown) for securing the connecting rod 150 to a crank shaft (not shown). The elongated connecting rod 150 defines an elongated rod oil passage 156 that has a first end 158 and an opposite second end 160 opening to the seat end 152. The seat end of the connecting rod 152 is bolted to the cross pin 130 using a pair of bolts 162 so that the second end 160 of the rod oil passage 156 is in alignment with the first end 136 of the cross pin oil passage 134. The cross pin 130 defines two spaced-apart threaded bores 131. The seat end 152 of the connecting rod 150 also defines two holes. Each of the holes 161 is in alignment with a different one of the threaded bores 131. A bolt 162 passes through each of the holes 161 and is in threaded engagement with the threaded bore 131.

To make a cross head piston of the type disclosed, a piston blank is forged from steel, using known piston forging techniques, so as to include the piston head 114 and two spaced-apart connection ears 120. Forging the piston blank results in a piston that is less susceptible to fatigue than a piston that is cast. The piston blank is machined so that the piston head includes the cylindrical wall 114, the lateral surface 116 and the ring grooves 140. The pin bore 126 is drilled through each connection ear 120 so that the pin bore 126 has a diameter that corresponds to the diameter of the cross pin 130. Thus, the cross pin 130 fits into the pin bore 126 without need for a bushing.

The above-disclosed embodiments provide several advantages over existing designs, including: greater strength than cast steel pistons, lower cost in manufacturing due to elimination of a sleeve locking mechanism, lower cost in engine rebuilds due to not having to purchase bushings to hold the cross-pin, better cooling due to oil passing through the oil passage into the open well, no need for oil return passages in the connecting rod (which may become plugged from ash and varnish due to high piston temperature) and interchangeability with existing cross-head piston designs, thereby eliminating the cost of purchasing new connecting rods. The embodiments disclosed above can use existing cross-head connecting rods, but allow oil to circulate freely in the oil well. Thus, they provide the advantages of both forged steel pistons and cross-head pistons to those replacing the pistons used in existing engines employing cross-head pistons. The above-disclosed embodiments also have the advantage over forged steel pistons of not requiring an external sleeve to hold the cross pin, as it is bolted to the connecting rod.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A piston assembly, comprising:
a. a cross-head piston including: a piston head having a cylindrical wall, a lateral surface and an opposite inward surface; two spaced-apart connection ears each having a proximal end and an opposite distal end, each proximal end affixed to the inward surface and each connection ear extending outwardly from the inward surface, each connection ear defining a pin bore passing therethrough adjacent the distal end; and a piston well defined by the inward surface and the connection ears; and
b. a cylindrical cross pin disposed coaxially with a central axis so as to be engaged with both pin bores, the cross pin defining a central cross pin oil passage, having a first end and an opposite second end, passing transversely to the central axis, the cross pin placed in relation to the piston head so that the second end of the cross pin oil passage is directed to the piston well.

2. The piston assembly of claim 1, wherein the cross pin is in direct contact with both mounting ears, without any intervening bushing.

3. The piston assembly of claim 1, wherein the cross-head piston comprises forged steel.

4. The piston assembly of claim 1, wherein the cylindrical wall defines at least one circumferential ring groove.

5. The piston assembly of claim 4, further comprising a ring disposed in the ring groove.

6. The piston assembly of claim 1, further comprising an elongated connecting rod that includes a seat end and an opposite crank end, the seat end being fastened to the cross pin between the connection ears.

7. The piston assembly of claim 6, wherein connecting rod defines an elongated rod oil passage having a first end and an opposite second end opening to the seat end, wherein the seat end of the connecting rod is fastened to the cross pin so that the second end of the rod oil passage is in alignment with the first end of the cross pin oil passage.

8. The piston assembly of claim 6, wherein the connecting rod is fastened to the cross pin with at least one bolt.

9. The piston assembly of claim 8, wherein the cross pin defines two spaced-apart threaded bores and wherein the seat end of the connecting rod defines two holes passing therethrough, each hole in alignment with a different one of the threaded bores, wherein the bolt passes through each of the holes and is in threaded engagement with the threaded bore aligned with the hole.

10. A piston assembly, comprising:
a. a cross-head piston made of forged steel and including: a piston head having a cylindrical wall, a lateral surface and an opposite inward surface; two spaced-apart connection ears each having a proximal end and an opposite distal end, each proximal end affixed to the inward surface and each connection ear extending outwardly from the inward surface, each distal end defining a pin bore passing therethrough; a piston well defined by the inward surface and the connection ears;
b. a cylindrical cross pin disposed coaxially with a central axis so as to be engaged with both pin bores and in direct contact with both mounting ears without any intervening bushing, the cross pin defining a central cross pin oil passage, having a first end and an opposite second end, passing transversely to the central axis, the cross pin placed in relation to the piston head so that the second end of the cross pin oil passage is directed to the piston well; and
c. an elongated connecting rod that includes a seat end and an opposite crank end that defines an elongated rod oil passage having a first end and an opposite second end opening to the seat end, the seat end of the connecting rod bolted to the cross pin so that the second end of the rod oil passage is in alignment with the first end of the cross pin oil passage.

11. The piston assembly of claim 10, wherein the cross pin defines two spaced-apart threaded bores and wherein the seat end of the connecting rod defines two holes passing therethrough, each hole in alignment with a different one of the threaded bores, wherein a bolt passes through each of the holes and is in threaded engagement with the threaded bore aligned with the hole.

12. A method of making a cross head piston that is connectable to a connecting rod with a cross pin defining an oil passage transversely therethrough, comprising the steps of:
a. forging a piston blank from steel so as to include: a piston head having a inward surface; two spaced-apart connection ears each having a proximal end and an opposite distal end, each proximal end affixed to the inward surface and each connection ear extending outwardly from the inward surface; and a piston well defined by the inward surface and the connection ears;
b. machining the piston blank so that the piston head includes a cylindrical wall and a lateral surface disposed oppositely from the inward surface; and
c. drilling a pin bore through each connection ear so that the pin bore has a diameter corresponding to a diameter of the cross pin so that the cross pin fits into the pin bore without room for a bushing to be placed therein.

13. The method of claim 12, further comprising the step of machining at least one ring groove circumferentially into the cylindrical wall.

14. The method of claim 13, further comprising the step of placing a ring in the ring groove.

15. The method of claim 12, further comprising the steps of:
a. placing the cross pin through the pin bores so that the oil passage is capable of directing fluids toward the piston well; and
b. affixing an elongated connecting rod, defining an oil passage therethrough, to the cross pin so that the oil passage of the connecting rod is in substantial alignment with the oil passage of the cross pin.

16. The method of claim 15, wherein the affixing step comprises bolting the connecting rod to the cross pin.
